(19) United States
(12) Patent Application Publication
(10) Pub. No.: US 2014/0278684 A1
(43) Pub. Date: Sep. 18, 2014

(54) SALON MANAGEMENT SYSTEM AND METHOD

(71) Applicants: Anthony N. MASCIARELLI, North Easton, MA (US); David J. MASHER, Rowley, MA (US); Halldor UTNE, Beverly, MA (US)

(72) Inventors: Anthony N. MASCIARELLI, North Easton, MA (US); David J. MASHER, Rowley, MA (US); Halldor UTNE, Beverly, MA (US)

(73) Assignee: SALON TARGET LLC, Easton, MA (US)

(21) Appl. No.: 14/212,884

(22) Filed: Mar. 14, 2014

Related U.S. Application Data
(60) Provisional application No. 61/788,973, filed on Mar. 15, 2013.

(51) Int. Cl. G06Q 50/10; G06Q 30/02; G06Q 10/10

(52) U.S. Cl. CPC G06Q 50/10; G06Q 10/1095; G06Q 30/0269
USPC 705/7.19

(57) ABSTRACT

A salon management system includes a server system connected by a network to a set of terminals that are provided in a salon. The salon management system can manage client appointments, employee schedules and support communications between employees in the salon to facilitate efficient operations. The salon management system can also maintain information about each client and during client appointments present targeted content to that client based on the information about that client in the system.

### CROSS-REFERENCE TO RELATED APPLICATIONS

This application claims benefit under 35 U.S.C. §119(e) of the U.S. Provisional Application No. 61/788,973, filed Mar. 15, 2013, the contents of which are incorporated herein by reference in their entirety.

### STATEMENT REGARDING FEDERALLY SPONSORED RESEARCH

Not Applicable

### REFERENCE TO MICROFICHE APPENDIX

Not Applicable

### BACKGROUND

1. Technical Field of the Invention

This invention relates to systems that assist with the management, operation and marketing for beauty salons, spas and similar businesses using networked computer systems. More particularly, the invention relates to a method and system that uses software controlled networked devices to help manage the day to day operations as well as assisting in generating revenue for salon owners and higher commission for salon service providers. The invention can include a marketing/advertising component that utilizes the audio-visual communications (e.g., advertising and information presentations) displayed on display screens or kiosks, to a known audience (e.g., salon clients). In some embodiments, each individual client's demographic and psychographic make-up are known thus providing the ability to target messages (ads) directly based on gender, age, lifestyle, purchases history, frequency data and many other specific characteristics in any combination.

2. Description of the Prior Art

As an industry, salons have yet to embrace technology in ways other industries have. Many salons operate without the use of a computer system or specific salon management software. They schedule appointments by writing them in an appointment book. However, even the salons that operate with computers and management software are limited because the software only provides basic functionality. The typical salon software usually provides the basic features necessary for the day to day operations of a salon, on one isolated network, storing all data locally and dependent on CDs or DVDs for system updates. These components include; scheduling appointments, POS, client data, inventory control, service maintenance, employee maintenance, gift card/certificate maintenance, transactions, payroll, time cards, reporting, email functions and mailing systems etc. Usually, the front desk staff utilizes and operates the software with computers located at the reception desk. Some salons add satellite computers or tablets (e.g., iPads™) in common areas for staff use. Front desk computers are accessed only by approved staff members. Most of the staff/service providers have limited access to information needed to perform their services for the day. The common area computers usually create congestion of multiple staff members hovering over the computer to see their schedule. Stylists/service providers are usually unsure if a client has booked with them unless they are told or they see the appointment after constantly checking the common area computer.

Usually the stylist/service providers use of a tablet poses more challenges, they have to search for it, physically hold the device, sometimes having to stop the service, it has a small screen with small type thus, difficult to maneuver and the battery life is limited. These software systems are not effective for increasing the salons bottom line or management of time and efficiency.

The typical salon software are not designed to solve the challenges salons face, including for example, increasing sales revenues from products, services or promotions, maximizing re-booking of client appointments, improving time efficiency, and enhancing the client experience. As an industry, increasing product sales has always been challenging. The national average is approximately 6% of service sales. Most experts agree it should be closer to 20%. Salon owners offer their staff countless seminars, purchase books and tapes, offered in house sales training, all to no avail. The facts are very few stylists possess the ability to consistently sell products. Stylists do not consider themselves sales people, some have a challenge initiating dialogue and in some cases they do not have the time. Stylists try to present to the client the products they recommend as they are being used, if time is a challenge, the recommendation is usually skipped. Up selling salon services becomes a challenge for stylists as well. Most stylists have difficulty initiating dialogue and usually wait for the client to inquire. Most stylists are unaware as to whether they have the time to add a service to their current client. Generally, stylists are only compensated for up selling of the services they perform, not other services that the salon offers. Usually the front desk engages clients with service offerings, promotions and product specials; however, this is rarely done consistently.

Salons that use software to capture client images, usually take these pictures at the front desk upon arrival in view of desk personnel and other clients. This leaves the client feeling awkward or uncomfortable. Some stylists take before and after pictures of their clients with their personal cell phones. This system is hard to regulate and shows no level of professionalism. The photos may be added to the album for reference or add them to their personal stylist portfolio collage booklet. This practice becomes time consuming for the stylist, constantly updating, and the booklet eventually becomes worn or dated. Another alternative is for the salon to purchase expensive professional styling books which show clients the latest popular styles. These become worn, ripped, and dated and must be replaced constantly.

When re-booking a client, this is usually done at the front desk. Some salons use a tablet (e.g. an iPad or Android device) however, it becomes impractical, expensive, small, difficult to use, easily lost, stolen or misplaced, and unreliable based on battery life. When the client is trying to re-book their appointment, they may need to revisit the stylist, who has since taken their next client, to ask them when they should come back, infringing on another client's time. This also results in poor client flow and congestion at the front desk. The front desk is a very congested high traffic area. Clients are making appointments, inquiring about services or products, rescheduling appointments, purchasing gift cards while desk staffs may be assisting other clients on multiple phone lines with the same things. The typical salon front desk receptionist usually receives personal calls for stylists and clients asking to speak to their stylists. They usually write notes which are left at the stylist station or may be relayed verbally. This is time consuming and distracting for the receptionist and notes fall into the stylist drawer adding more clutter. Salon management may post messages in staff lunch/break rooms or areas where staff congregate, to informing them of staff meetings or announcements. However, this is an unreliable method as some staff members neglect to see the message.

Communication among staff (e.g., stylists and service providers) and front desk has always been a challenge, especially when a stylist/service provider is servicing a client or running behind schedule. The stylist needs to stop the service they are performing and leave the client in order to notify the front desk or they must gain someone's attention to relay the message to the front desk. They may signal with gestures, or verbally across the room, resulting in an uncomfortable atmosphere as well as lowering the level of professionalism within the salon.

### SUMMARY

The present invention is directed to a method and system for managing information that can be transferred and displayed to employees and customers in a salon or spa. In accordance with the invention, a two or more terminals and a server can be connected to a network that enable salon information to be exchanged. The server can store information about the employees, the clients and the appointments during which the employees provide services to the clients. The server can store information about each client including client demographic information, service and product purchase history and any preferences. The server can also include promotional information about product and service advertisements, salon promotions and information about products and services provided by the salon. The server can use the information about each client to select specific targeted product and service advertisements, salon product and service promotions and information about available products and services provided by the salon that are more likely to appeal to that client and display them for that client when the client is in the salon for an appointment. The system can update the service and product purchase information about each client to refine the information about client preferences and the content provided to that client during future appointments. The terminals can enable clients interact with the system to get more information about content presented to them, including making product and service purchases at the salon.

The present invention includes methods and the systems for providing services using a secured cloud-based software and hardware system. The system can provide for more efficient operations, better management of time, an increased level of communication, and a unique client experience. The system can provide a dynamic in-salon advertising platform for local or national businesses as well as the salons themselves. By providing terminals in various forms (e.g., including touchscreen computers, kiosks, tablets and workstations) to salons, that can be installed at every station (e.g., hair stylist's station, nail & pedicure stations, as well as any other station locations). These terminals can be strategically at some or all of the stations so that clients can have an unobstructed direct view of the content presented while receiving services provided by the salon or waiting to be provided services by the salon.

The system can utilize web based software and can be run at multiple user levels, each having different access privileges. The types of users can include, for example, a stylist, a service provider, an advertiser, an owner, a distributor or a client. Any computer, chosen by the salon owner, for the “front desk”, will utilize the salon/spa's administration system. All in-salon computers registered to this account, including kiosks, “front desk”, service common areas, etc., will be installed and connected to a WIFI router for internet access, thus connecting to the cloud server for account management, data storage and acquisition. The salon administration system can be accessed from any location where internet connectivity is available and the user has the correct authentication. The kiosks plug directly to the outlets already provided by the stations and are secured using proprietary mounts that position the kiosk at a specific height and tilt for optimal client viewing and stylist's usability. The stylist or the client may easily maneuver around the software simply by touching the screen. Clients have the ability to utilize the proprietary touchpad, mouse both on the left and right armrests of the styling chair. This allows the client to easily maneuver around the software without leaning forward or disrupting the flow of the stylist's performance.

### BRIEF DESCRIPTION OF THE FIGURES

The accompanying drawings, which are incorporated into this specification, illustrate one or more exemplary embodiments of the inventions and, together with the detailed description, serve to explain the principles and applications of these inventions. The drawings and detailed description are illustrative, not limiting, and can be adapted without departing from the spirit and scope of the inventions.

FIG. 1 shows a diagram of a system architecture according to one embodiment of the invention.

FIG. 2 shows a diagram of examples of user level work flows according to one embodiment of the invention.

FIG. 3 shows a diagram of process flows according to an embodiment of the invention.

FIGS. 4A-4C show screen displays of a customer check-in process flow according to an embodiment of the invention.

FIGS. 5A-5I show screen displays of a client in-session process flow according to an embodiment of the invention.

FIGS. 6A-6D show screen displays of a client preferences entry/change process flow according to an embodiment of the invention.

FIGS. 7A-7E show screen displays of a client profile image process flow according to an embodiment of the invention.

FIGS. 8A-8F show screen displays of a stylist recommended products configuration process flow according to an embodiment of the invention.

FIGS. 9A-9D show screen displays of a customer purchase history process flow according to an embodiment of the invention.

FIGS. 10A-10E show screen displays of a customer reservation history process flow according to an embodiment of the invention.

FIGS. 11A-11F show screen displays of a customer images management process flow according to an embodiment of the invention.

FIGS. 12A-12B show screen displays of a display mode process flow according to an embodiment of the invention.

FIGS. 13A-13G show screen displays of a promotions process flow according to an embodiment of the invention.

FIGS. 14A-14E show screen displays of a customer appointment booking process flow according to an embodiment of the invention.

FIGS. 15A-15C show screen displays of a portfolio management process flow according to an embodiment of the invention.

FIGS. 16A-16F show screen displays of a kiosk alert process flow according to an embodiment of the invention.

FIGS. 17A-17G show screen displays of a service provider profile process flow according to an embodiment of the invention.

FIGS. 18A-18E show screen displays of a salon information presentation process flow according to an embodiment of the invention.

FIGS. 19A-19G show screen displays of a customer check-out process flow according to an embodiment of the invention.

### DETAILED DESCRIPTION OF PREFERRED EMBODIMENTS

The present invention is methods and systems for controlling the flow of information that can be used to manage a salon or spa. The system can include two or more terminals interconnected via a network that can be used to manage the operations of the salon or spa. By managing appointments and tracking clients, the system can also provide targeted content to the salon's clients that can enhance their experience and make them aware of additional products and services that are available to them.

The present invention includes methods and the systems for providing services using a secured cloud-based software and hardware system. The system can provide for more efficient operations, better management of time, an increased level of communication, and a unique client experience. The system can provide a dynamic in-salon advertising platform for local or national businesses as well as the salons themselves. By providing terminals in various forms (e.g., including touchscreen computers, kiosks, tablets and workstations) to salons, that can be installed at every station (e.g., hair stylist's station, nail & pedicure stations, as well as any other station locations). These terminals can be strategically at some or all of the stations so that clients can have an unobstructed direct view of the content presented while receiving services provided by the salon or waiting to be provided services by the salon.

FIG. 1 shows a diagram of a networked computer system 100 that can support the salon management system according to the invention. In accordance with some embodiments of the invention, the system can include cloud based server system 110 (e.g., the Salon Target Cloud) that can host the salon management system and provide access to the system using an HTML or web-based user interface. The Salon portion 120 of the system can be connected to the cloud based server system 110 using the internet or a proprietary network 132. The Salon Target System can include one or more front desk terminals 122 and one or more kiosks 124 connected to the salon network that provides a connection to the cloud based server system 110 over the internet. The Salon Target System 110 can also be accessed by others outside of the salon by connecting over the internet.

Other people that can access the Salon Target System 110 can include salon clients, Salon Target System administrators, one or more salon owners or salon manager and advertisers. Salon clients can also access the Salon Target System 110 to schedule and change appointments, make product purchases and to inquire about content that was presented to them while they received services at the salon. The Salon Target System administrators can access the system 110 to perform administrative functions, such as trouble-shooting, system maintenance and backup and account management. The salon owners and/or managers can access the system to perform salon management functions, such as managing employee hours and payroll, product inventory and ordering, financial accounting of the business operations, obtaining access to performance information relating to each of these. For example, the system 110 can keep track for each stylist (employee) the number of client's serviced, the total amount of revenue generate over a time period and on a per client basis, the amount in additional products and services sold by that stylist, and other related information. The advertisers can access the system 110 to search de-identified client demographic information and preference information and match it with advertiser content that is made available to the server system 110 for delivery to salon clients.

FIG. 2 show a diagram of some of the available workflows that can be provided by a salon management system 110 according to some embodiments of the invention. FIG. 3 shows a diagram of some of the process flows between users of a system according to some embodiments of the invention. The salon owner or manager can log into the administrator (admin) system with the appropriate credentials and access all or almost all aspects of the system. The admin system can include a control panel that provides access to all available functions, including stylist/employee functions and front desk/reception functions. The owner can communicate with stylists/employees and the front desk/receptionists using this system as shown in FIG. 3. Similarly, each stylist/employee can access the employee system that provides information to the employee about their schedule, their appointments, and their clients. The employee can also notify the system that the employee is busy with a client or available to take their next client and this information can be transmitted to the front desk to notify the receptionist to take the appropriate action. When a client arrives at the salon, the stylist can be notified with an alert that the client is waiting and if the stylist is ready for the client, the front desk can be notified and the client brought to the stylist for services. When the stylist is delayed or needs assistance, the stylist can send an alert to the front desk notify the receptionist who can provide assistance or ask another stylist to provide assistance. In accordance with some embodiments, the employee system can broadcast an alert to some or all of the other employees requesting assistance. The alerts can be preconfigured with common messages, for example, “I am running behind, can another stylist finish with my current client.” The receptionist can use the front desk system to check clients in and out of the system. The front desk system can be used to enter and change appointments, record payment transactions for services and send and receive notifications with the stylists and the owners. In accordance with some embodiments of the invention, the messages and notifications can be sent to the cloud based server system which can update the information displayed on the recipient terminal. In accordance with some embodiments of the invention, the messages and notifications can be sent directly to the recipient terminal.

The system can utilize web based software and can be run at multiple user levels, each having different access privileges. The types of users can include, for example, a stylist, a service provider, an advertiser, an owner, a distributor or a client. In accordance with some embodiments of the invention, the system can include a salon administration system. Any computer, chosen by the salon owner and accessed using the owner privileges can utilize the salon/spa's administration system. All in-salon computers accessed using this owner account, including kiosks, the front or reception desk terminal, and station terminals can be connected to the salon network using either wire or wireless network connections and obtain access to the server. In accordance with some embodiments of the invention, the salon management system can be hosted by a server that can be located remotely from the salon or hosted remotely by a third party or provided as a cloud based service. The salon management system can provide account management, and data storage and acquisition. In accordance with some embodiments, the salon administration system can be accessed from any location where internet connectivity is available and the user has the assigned credentials and privileges.

The wired or wireless terminals can be incorporated into wireless kiosks that plug directly to the outlets already provided by the stations and are secured using mounts that position the kiosk at a specific height and tilt for optimal client viewing and stylist's usability. The stylist or the client can easily interact with the system using a simple touch screen interface. Clients can be provided with user interface device, such as a touchpad, trackball or mouse on one or both armrests of the styling chair. This allows the client to easily interact with the system without leaning forward or disrupting the flow of the stylist providing their service.

The innovative proprietary software allows the front desk admin computers and the kiosks to communicate with one another as well as kiosk to kiosk. As the client arrives for their scheduled appointment, the receptionist using the software, checks in the client by changing the status from “pending” to “waiting”. This updates the appropriate stylist kiosk alerting them their client has arrived. If time is available the receptionist will update the client's personal information as well as set preferences relating to their profile, content or ads. The stylist then escorts the client from the waiting area to the styling station. At this time, the client is viewing untargeted default advertising and content “infotainment”. The stylist enters their personal 4 digit pin code from the touchscreen kiosk or uses the biometric fingerprint reader which will authenticate and provide access to the kiosk and route all of the data relating to the stylist, client, salon products and services, promotions, images, ads, and content to that kiosk as long as the client is “In-Session”. The profile of the current client appears on the screen along with other clients scheduled for the day. The stylist then selects the “in-session” button, if the client is a regular base client, the software recognizes the client and activates the display on the kiosk automatically generating targeted “last minute services”, “service promotions”, “product promotions”, targeted advertising and targeted content. If the client is a new or first time client, the stylist chooses the “preferences” button. The innovative Salon Target System preferences are checked by the stylist with input from the client, this involves gender, age, ethnicity, hair length, hair type, hair thickness, hair texture, hair color, chemical treatments, hair concerns, preferred styling results, preferred finished look, formulation, ingredient allergy, ingredient preference, services preferred, tools & brushes used, frequency of hair washed, time & effort devoted to styling, etc. Each preference selected and answered determines product recommendations, additional services, applicable promotions and any advertisement, and content that will display on the kiosk. This prompts the stylist to present and up sell products, services or promotions quickly and effectively during the scheduled service without adding more time. Preferences can be modified at any time producing different results. Preferences categories can be added, modified or deleted only by Salon Target System Administrator. After the preferences are set for each client, the kiosk will automatically display said preferences on the client profile page for review and future reference. If there is a current service or product promotion being offered that is related to a preference, that preference will be highlighted flashing prompting the stylist to visit the promotion page to inform the client. Specific products that match the clients' preferences also appear on the client profile page, activating and displaying the “last minute service”, “service promotions” and “product promotions that coincide with the preferences. The stylist/service provider from the group of matched products displaying on the profile page can recommended products by tapping on “See All”, which displays all salon offered product brands with categories, from the group of matched products, the stylist's maneuvers to the desired products and simply taps the check box to select that product as the stylist's professional recommendation. Once the recommended shampoo, conditioner, styling product and finishing products are selected, those 4 product recommendations appear first on the client's profile page. During the service, the client is informed of the products benefits, available sizes, prices and related products. The stylist is able to offer a unique experience for every client, efficiently and professionally up selling products during the service without spending additional time. If the client chooses to purchase products, the stylist simply taps on the product, selects the quantity the item and price automatically is added to the client's shopping cart. The shopping cart items and total appears on the “cart button” on the client profile page for display. The kiosk will automatically return to display mode after 60 seconds of inactivity if the stylist does not manually tap on the “display” button. Display mode will show targeted “last minute services”, “service promotions”, “product promotions”, targeted advertising and content all specific to the current client offering a unique and enhanced client experience. The last minute service is a unique feature that allows the salon owner to consistently promote on every kiosk, specific services with dynamic images, descriptions, benefits and prices that may be available as last minute discounts. This will fill unscheduled appointments at the last minute providing income that otherwise would have been lost. The salon owner simply chooses any service they wish to promote at any price. This service will display if the available time of the service falls immediately following the current client's session. This is achieved by a user logged in as an administrator at the desk or from a location with internet connectivity, where the service chosen is activated as last minute service. The service image, description and price can be modified. Once the last minute service is set, it will display only on the kiosks if, the service is in fact available and if it matches the preferences of the client in the chair. The last minute service will show remaining minutes left to choose the service building urgency. The images of the services can be selected by the salon owner from the pre-loaded Salon Target System images. This with the preferences allows the salon owner to display the service with a gender specific image to display to that same gender of the client. If the client wishes to take advantage of the last minute service, the stylist or client simply taps on the last minute service box to bring up the “Book Now” or “Add to Cart” button. When the book now button is pressed, minute service time with the specific service providers available that can perform the service. Once the service provider is chosen, the last minute service disappears from the kiosk and the appointment with the client's name downloads on the scheduler of the Salon Target System Admin where the receptionist is alerted. The unique service promotions feature allows the salon owner to promote services with dynamic images, descriptions, benefits and prices, from the Salon Target System Admin, to choose and activate any service as a “service promotion”. The service image, description and price can be modified. Once the service promotion is set, it will automatically display on the kiosk if the service promoted matches the preferences of the client in the chair. The images of the services are selected by the salon owner from the pre-loaded Salon Target System images. This with the preferences allows the salon owner to display the service with a gender specific image to display to that of the client. If the client wishes to take advantage of the service promotion, the stylist or client simply taps on the service promotion box to bring up the “book now” or “Add to Cart” button. If the book now button is pressed, the “book scheduler” appears with buttons reflecting preferred future months, weeks, days and time blocks. Once the date and time block are selected, a selection of specific service providers that perform the service along with their specific available times of the day. Once the service provider along with available time is chosen, a confirmation appears on the kiosk and a confirmation is sent directly to the client's email. If “Add to Cart” button is pressed, it is automatically sent to the client's cart. The cart items and total appears on the “cart button” on the client profile page for display. The product promotions feature allows the salon to offer any product they wish to promote consistently and effectively. From the Salon Target System Admin, the salon owner chooses and activates any product as a “product promotion”. The product displays with dynamic images, description and price which all can be modified. Once the product promotion is set, it will automatically display on the kiosk if the promoted product matches the preferences of the client in the chair. The images of the products are selected by the salon owner from the pre-loaded Salon Target System images. The unique preferences allow the salon owner to promote the product with a service. If the client wishes to take advantage of the product promotion, the stylist or client simply taps on the product promotion box to bring up the quantity box. Once the quantity is chosen the item and the price is automatically sent to the client's cart. The cart items and total appears on the “cart button” on the client profile page for display and the front desk is alerted of the purchase on the Salon Target System Admin Software. This allows the receptionist to gather the products and deliver them to the client to take home.

If the client has a history of past services received, it will display on the client profile page under “recent reservations”. This allows the stylist to quickly view client history so they can make informed decisions on re-booking appointment types and dates. From history, the stylist can confidently re-book appointments quickly and efficiently. The stylist can view the last 3 past services or tap on “See All” button to view more. The date of service, service received and employee display on this page. Below on the client profile page displays “Recent Product Purchases”, where the stylist/service provider can quickly view and resell last purchases. The stylist can view the last 3 purchases or tap on “See All” button to view more. The date purchased, item image, title, description and price display on this page.

Any time during the appointment/session the stylist can present and up sell to their clients, additional services they provide as well as any services the salon offers. The stylist/service provider simply taps the “service” tab to display the service categories, titles and descriptions. This allows the salon owner a unique ability to incentivize the stylist/service provider since each kiosk stores all activity for easy reporting. This innovative platform allows stylist/service providers to easily engage their clients and increase sales. By tapping on the title, the full image appears with description, price, and related services. The service can be scheduled by choosing the “Book Now” button.

Any time during the appointment/session the stylist can present and up sell to their clients, any product the salon offers, by simply tapping the “products” tab to display the product brand, categories, sub categories, titles, description/benefits, available sizes and prices. This feature allows the stylist/service provider to present and up sell products quickly with ease. By tapping on the title, the full image appears with description, price, related products, and available sizes with an add quantity button.

Salon Target System displays a photo of the client on their profile page and becomes the image of record for the client's account. The photo is taken directly from the kiosk when the stylist/service provider taps the image placeholder on the client profile page to activate the onboard camera. Since the client is already positioned in front of the camera, the process is quick and non-intrusive. The stylist simply taps the “Capture Image” button which then displays image on the profile page. The client can choose among multiple pictures, which one is featured on the profile page. This feature allows stylists to reference images of clients they may be servicing who usually see a different stylist that either may be out sick or on vacation. This helps the stylist's confidence and puts the client at ease knowing there are photos stored of their preferred look. The “images” tab allows the stylist to view current images of the client, capture new pictures of the client, update client image tags and maintain the catalog of the client images. Also, these images can be added directly to the stylist's portfolio (My Portfolio) page.

Salon Target System features a “Check-Out process” where the service provider, when finished with the client's service, can close the session, or they can check the client out from the chair. The service provider simply taps the “Session Completed” button on the kiosk. This closes the session, alerts the front desk and displays a pop up window on the kiosk asking if the client would like to check out at the chair with either of two methods of payment, instead of a the front desk. The tow payment methods are using your credit card that the salon has on file or using our kiosk camera to scan a QR Code or Bar Code displayed on the client's smart phone (such as Google Wallet, Level Up, Pay Pal, etc.). If the client chooses to use their stored Credit Card, they simply review the transaction/check out screen and approve payment. The service provider taps Cash Out. A receipt is sent to the client via email and the front desk is notified.

If the client chooses to scan a QR or Bar Code first review and approve the transaction/check out screen. Once approved the stylist taps the scan button and the client holds their phone up to the camera. Once the core is captured, their credit card is charged the balance and a receipt is sent to the client via email.

At any time during the appointment the stylist can quickly and efficiently rebook any past service the current client has had regardless of which stylist provided the service. This is done by tapping the “rebook” tab at the top of the kiosk screen and then choosing a past service from the list. The stylist then chooses the date and then taps “Book Now”. This adds the appointment to the salon schedule with the corresponding service. A confirmation email is automatically sent to the client. This allows increased consistent re-booking for the salon, a more convenient process for the client and less congestion at the desk.

The “portfolio” section consists of “My Portfolio”, “Salon Portfolio” and “Salon Target Gallery”. “My Portfolio” is an individual stylist's repository of client photos of the clients they service. Photos are added to this list only when approved by the client. This feature allows the stylist to present dynamic client images and quickly maneuver through the images when presenting their professional work to a new client. The “Salon Portfolio” is the entire salon stylist's repository of client photos of the clients they service. Photos are added to this list only when approved by the client and clients can only view the photos in their own gallery. The Salon Target Gallery is a subscription based library of images featuring current trends in hairstyling. When a Salon Target System salon owner subscribes to the “Salon Target Gallery”, each stylist/service provider will have access to a full library of professional images featuring current hairstyles, haircuts, hair colors and hair treatments to showcase to their clients. This library has a built in filtering system to assist stylists/service providers to quickly locate styles by gender, ethnicity, hair type, and hair color. If a client sees an image they like, that image can be chosen and stored to the client's images page for future reference. This will replace the typical books of hair styles that salons currently purchase and use.

“My Profile” Is essentially the stylists/service provider's virtual desktop where information related to them is entered and stored by the salon owner using the Salon Target System Admin Tool. The “profile” tab is chosen to display information such as stylist's bio and personal images that the stylist would like their clients to see. Stylist/service providers can also access their “work schedule” showing all booked and available appointments, future and past appointments can be seen using the interface.

The unique “alert” feature is essentially a messaging system used to notify the service provider of any messages and announcements. This allows the front desk to communicate with any or all kiosks through the Salon Target System Admin Tool. Salon owners, approved third-party vendors or anyone who has approved access and privileges can post a message to the service provider via the Salon Target System website. The service provider is made aware of an alert when the “My Profile” button is highlighted in green. Once the alert has been read, the “My Profile” button color is reset.

The “time card” tab is activated and displayed when an employee's payment method is set as hourly in the Salon Target System Admin. The stylist/service provider essentially uses the time clock to record start times and end times reflecting hours worked for the day and breaks taken. The stylist/service provider can easily review time card history.

“About Us” is where salon owners, similar to their websites, can inform clients of the salon's mission statement, history and company information. Basically any information the salon owner would want their clients to be informed of. The “About Us” page is created and managed by the salon owner within the Salon Target System Admin Tool. The salon services and products listing can be created and managed on the “menu” tab by the salon owner, using the Salon Target System Admin Tool. The stylist/service provider can tab on any of the menu items to bring up images and listing of services.

Salon Target System features an “Advertiser List” tab that displays the current list of advertisers that are running ads within the salon. This allows stylists to assist clients with specific information about an advertiser. This list is populated by the Salon Target System Adserver.

Salon Target System Advertising Engine (Adserver)

The Salon Target System Adserver can be used to serve targeted ads to targeted machines (kiosks), not webpages. This is a push technology (no request needed from user to display ads) unlike that of browsing a website and having ads appear after the user clicks a link (pull technology, or request by user). This targeting is based on matching and authenticating the salon or spa client's preferences to advertiser requested demographics. Once a client at the kiosk is authenticated by the stylist/service provider, targeted ads are pushed to that specific client's kiosk based on the client's demographics that match those required by the advertiser. This guarantees the advertiser's ads are displayed to their defined audience. The advertiser, once logged into the Salon Target System website can register to advertise on the network. They can choose from a selection of templates in which they can upload their logo and create their custom advertisement. They may choose the salon(s) within selected towns and cities (geotargeting), the client age group and gender and/or other selected preferences. Once the advertiser has submitted their payment, the advertisement is then pushed to specific kiosks when the targeted client sits in the stylist/service provider's chair and the session is initiated by the stylist, and if the targeted client matches the advertiser's demographic needs.

The next section provides a more detailed description of the workflows that can be provided at each of the terminals.

### Salon Target Kiosk System

### Customer Check In

### Overview

Once the client arrives for a pre-booked appointment, the receptionist changes the status of the client's reservation from pending to “waiting”. This updates the status of the reservation on the service provider's kiosk as well.

### Method

1. The receptionist, logged in as a receptionist, chooses “Dashboard” from the main navigation links at the top of the administration site.
2. The receptionist now clicks on the row for this reservation and the reservation pop-up opens as shown in FIG. 4A.
3. As shown in FIG. 4B, the receptionist clicks the “Check-In” button and the popup closes.
4. The reservation status on the service provider's kiosk is updated to from “Pending” to “Waiting” as shown in FIG. 4C.
5. Receptionist escorts the client to waiting area to be seated.
Client is in-Session

Stylist escorts the client to the station. Once at the station the client sees untargeted house ads and content being displayed on the kiosk. As shown in FIG. 5A, the stylist enters the 4 digit PIN code from touch screen (or uses the biometric fingerprint reader) which will authenticate the stylist and provide access to the kiosk and route all of the stylist's data to this kiosk.

Once logged in the stylist's schedule appears displaying the clients for the day, as shown in FIG. 5B. The stylist selects from the list of clients, the current client and sets the reservation status to “In-Session”, as shown in FIGS. 5C-5D. This activates the client's profile and enables targeting system. The stylist then reviews the client's information, making sure it is current. This involves checking preferences for client hair, skin and body needs as well as uniquely targeting products, services, ads and content. After Preferences are set the results are displayed on the client's profile. If a client preference, on the client's profile page, is highlighted, it alerts the stylist of a product or service promotion related to that preference. Preferences can be modified by the stylist at any time on the kiosk.

The results of the selected preferences link specific products to that client, aiding the stylist in choosing correct products to match the need of the client. These Preferences also set related products, services, content and ads to be displayed to the client when in Display Mode. The stylist may at this time show the client recommended products. When finished the stylist taps the Display button returning to Display Mode, however, now all the content, ads and promotions are targeted to this client.

### Method

1. Stylist taps in the 4 digit PIN code into the kiosk or authenticates their fingerprint. Once logged in, the kiosk displays the stylist's data, including: schedule, profile, today's appointments, alerts, products, services, etc.
2. Stylist taps the current reservation and sets the reservation status to “In-Session”, as shown in FIGS. 5C-5D. This engages the targeting engine and displays all of the client's information. The stylist then changes the status of that reservation to “In-Session” which changes the status on the Receptionist's display as well, as shown in FIG. 5E.
3. Stylist taps the “Preference” tab from the top of the kiosk screen. (FIG. 5F) This displays the client's Preference Library. This is a list of preference, buttons, allowing the stylist to set the clients preferences. Buttons with a black outline designates unset preferences.
4. Stylist taps a preference button. This opens a window where the stylist can check the preferred preference and save the choice. (FIG. 5G)
5. As preferences are set, the targeting engine begins to set related products, services, content and ads to be displayed to the client.
6. When finished entering data, the stylist can tap the “Display” button (FIG. 5H) from the Kiosk Main Navigation area setting the kiosk to Display Mode, showing targeted content, ads and promotions. Or the stylist can simply do nothing and the system will automatically set the kiosk into Display Mode after 30 seconds. (FIG. SI)

### PREFERENCES

The Preference engine and set up (tagging) are the heart of the Salon Target System. The service provider asks the client questions about their hair, body and skin, and their product, service and entertainment preferences. These are tagged by the service provider within the client's profile. (FIGS. 6A-6D) Once complete, the preference engine matches products, services, content and advertising to the individual client. Preferences can be added or modified at any point by the service provider. These tagged preferences are used to create a unique experience for the client and to facilitate salon efficiency, bringing added revenue. This data, in aggregate with no personally identifiable information, will eventually be used for data-mining.

### Method

1. With the client in the chair the service provider taps the “Preference” tab at the top of the kiosk as shown in FIG. 6A. This displays the Preference Library. (FIG. 6B)
2. The service provider then taps each of the preference buttons, taps the requested choice from the client and saves the preference selection. (FIG. 6C)

The default preference library can contain the following but can be modified at any time by Salon Target System Administrators:
Gender—tags products, services, content, third-party and in-house salon ads, images as well as targets gender image for product and services displayed on the kiosk. For example a hair cut service for a male will display a male image in the service detail and a hair cut for a female will display an image of a female getting a hair cut in the service detail
Age—tags products, services, content, third-party and in-house salon ads, images as well as targets correct image for prod and services displayed on the kiosk
Client Ethnicity—tags products, services, content, third-party and in-house salon ads, images as well as targets correct image for prod and services displayed on the kiosk
Hair Length and Type—tags products, services, ads, images
Hair thickness texture and color—tags products, services, ads, images
Chemical Treatments—tags products, services, ads, images
Hair concerns—tags products, services, ads, images
Preferred Styling results—tags products, services, ads, images
Preferred Finished Look—tags products, services, ads, images
Ingredient Allergy/Preference—tags products, services, ads
Formulation—Tags products, ads
Services Preferred—tags products, services, ads, images
Tools and Brushes Used—tags products, services, ads, images
Hair Washed/Time and Effort—tags products, ads, images
   3. The client's profile now reflects these preferences in the “Preferences” area. (FIG. 6D) The “Stylist Recommended Products” are now matched to the client's preferences

### Profile Image

This is the photo of the client that appears on their profile page and becomes the image of record for the client's account. To take a new photo of the client, the stylist simply taps on the image placeholder on the client profile page. This activates the onboard camera. The client is already positioned in front of the camera, the stylist taps the “Capture Image” button. The image is then displayed on the client profile page. If the client's image gallery contains more than one image, they may choose which one is featured on the profile. (FIGS. 7A-7E)

### Method (Taking the First Client Photo)

1. With the client in the chair, the stylist taps the image placeholder image on the client's profile page as shown in FIG. 7A. This displays the capture screen and activates the onboard camera.
2. A live camera view is displayed, two capture options: “capture image after 3 seconds” and “Capture image instantly” and the “Return to Image Gallery” button. (FIG. 7B)
2a. The stylist can exit this screen and shut down the camera at any time by tapping the “Return to Image Gallery” button.
3. The stylist taps either of the two capture buttons. One giving a three second displayed countdown and the second taking the picture instantly.
4. The screen flashed full white, simulating a flash and providing light for the photo
5. The new image is now displayed in the “Captured Image” window along with a message notifying the client and stylist that the capture is complete. (FIG. 7C)
6. If the client is happy with the captured photo, the stylist taps the “Save Image” button. The image is added to the client image gallery and is placed on the client profile page and becomes the image of record for the account. (FIGS. 7D-7E)

### Stylist Recommended Products

Within the client's profile there are four categories of related product: shampoos, conditioners, styling products and finishing products. These Kiosk Product Categories and preferred brand are set by the salon owner from within the Salon Target System Company Setup module of the System Administration tool. The products displayed on the client's profile page are based on the Preferences chosen by the client. (FIGS. 8A-8F)

Prior to the client's arrival, the stylist can set the recommended products from the list of preferred products for any client on today's schedule. From the client's profile page the stylist taps the “See All” recommended products link, the 4 product categories are display along with the addition of a Protools Category. The stylist navigates their way to the subcategory. A subcategory with an * indicates that subcategory's products have the highest preferred rating, based on the clients preferences. Once the Subcategory is tapped, the preferred products are displayed. The stylist can recommend a product in this list by simply checking/tapping the “recommended” box. This product will now display in the appropriate category on the client's profile page under “Stylist Recommended Products”. This recommendation can be modified at any point by the stylist.

Should a client want to learn more about one of the Stylist Recommended Products, the stylist can tap on any of the recommended products and display the full product detail along with the price, available sizes, related products as well as the ability to add that product to the client's shopping cart.

### Method (Designating a Stylist Recommended Product)

1. On the day of the service, the stylist taps the “See All” link in the “Stylist Recommended Products” section of the kiosk. (FIG. 8A) This displays the four “Stylist Recommended Products” categories with the addition of the “Pro Tools” category. (FIG. 8B)
2. The stylist taps the category, for example “Conditioner”. This displays the brands for that category that are in inventory. (FIG. 8C)
3. The stylist taps the brand, for example “Paul Mitchell”. This then displays the subcategories. (FIG. 8D)
4. The stylist then taps the subcategory of their choice, for example “Extra Body”. This displays the list of products. (FIG. 8E)
5. To recommend a product, the stylist taps/checks the “Stylist Recommended” box with in the product row. (FIG. 8E)
6. The “Stylist Recommended Product” is now displayed on the client's profile page. (FIG. 8F)
7. This recommendation can be modified at any point by the stylist.

### Method (Showing Client the Stylist Recommended Product)

1. With the client in front of the kiosk and the Client Profile displayed, the stylist taps on any of the “Stylist Recommended Products”, this displays the full product detail along with the price, available sizes, related products as well as the ability to add that product to the client's shopping cart.
2. The stylist can add the product to the client's shopping cart buy tapping the add to cart button.
3. The stylist can choose a different size, for example 3 oz., 10 oz., 1 gallon etc. by tapping that product. This also displays the full product detail along with the price, available sizes, related products as well as the ability to add that product to the client's shopping cart.
4. The stylist can choose a Related Product from the list at the bottom of the Stylist Recommended Products page. A related product relation is based on the classification and tagging of the original product done by the salon owner in the Salon Target Sytem Administration tool.

### Recent Product Purchases

The client's profile page displays an abridged history of “Recent Product Purchases”. These products can be tapped, displaying the full product detail along with the price, available sizes, related products as well as the ability to add the product to the client's shopping cart.

Method

1. From the client's profile page, the stylist taps either an individual “Recent Product Purchase” link or the “See All” link in the “Recent Product Purchases” area. Either will display a list of “Recent Product Purchases”. (FIG. 9A)
2. The stylist can scroll through the list of “Recent Product Purchases” and simply tap the “add to shopping cart” button on any of the “Recent Product Purchases”. For more information on any product the stylist can tap anywhere in the product row which displays the full product detail along with the price, available sizes, related products as well as the ability to add that product to the client's shopping cart. (FIGS. 9B-9D)

### Recent Reservations

The client's profile page displays an abridged history of Recent Reservations. Tapping on the “see all” link displays the history of services sorted by date. The stylist may rebook any appointment from history. (FIGS. 10A-10E)

### Method

1. From the client's profile page, the stylist taps either an individual “Recent Reservation” or the “See All” link in the “Recent Reservation” area. Either will display a list of recent reservations. (FIG. 10A)
2. The stylist can scroll through the list of “recent reservations and simply tap anywhere in the row containing the recent reservation. (FIG. 10B) This displays the Booking Widget. (FIG. 10C)
3. Stylist selects a week from the “How Many Weeks Out” category. (FIG. 10C)
4. Stylist taps the client's preferred day. (FIG. 10C)
5. Stylist taps the client's preferred time. (FIG. 10C)
6. A columns of available reservations/providers are now displayed. The far left column is highlighted blue, showing the current stylist's open appointments if available.
7. Stylist taps the preferred reservation and a “Book Now” button is displayed containing the reservation information. After review by the client, the stylist taps the “Book Now” button and a conformation screen is displayed. (FIG. 10D) This also triggers a conformation email to be sent to the client. Both the service provider and the salon schedules are updated with this new reservation. (FIG. 10E)

### Images Tab

The image tab allows the stylist to view current images of the client, capture new pictures of the client, update client image tags and maintain the catalog of the client images. It also is where you add client images to the stylist's “My Portfolio” page. (FIGS. 11A-11F)

### Method

1. Stylist taps “Images” tab from the top of the kiosk screen. (FIG. 11A) This displays the current library of client's images and a button to take a new picture. (FIG. 11B)
2. To capture a new image the stylist taps the “Capture new image” button. This displays a live camera view, two capture options: “capture image after 3 seconds” and “Capture image instantly” and the “Return to Image Gallery” button. (FIG. 11C)
2a. The stylist can exit this screen and shut down the camera at any time by tapping the “Return to Image Gallery” button.
3. The stylist taps either of the two capture buttons. One giving a three second displayed countdown and the second taking the picture instantly.
4. The screen flashed full white, simulating a flash and providing light for the photo and the new image is now displayed in the “Captured Image” window along with a message notifying the client and stylist that the capture is complete.
5. The stylist can now save the image to the client's photo gallery by tapping the “Save Image” button or retake the photo using the capture buttons as before.
6. Once “Save Image” is tapped, the screen displays the full size version of the captured image along with four control buttons: Add to Salon Gallery, Image Rating, Set as Profile Image and Delete Image. (FIG. 11D)
6a. Tapping “Allow Usage in Portfolio” displays a screen with the image you would like to add to the Salon Gallery, and then you have the choice to confirm the addition of the image to the Salon Gallery or decline. If the client approves the addition of the image to the Salon Gallery, the stylist taps “Yes” and then “Save”. The stylist can now add this to their gallery by tapping the “Add Image to My Portfolio” button. The image now will display on the stylist's Portfolio page.
6b. Tapping “Image Rating” allows the client to rate the image for future reference. (FIG. 11E) There are four ratings: “Love it!”, “Like it.”, “It's OK . . . ” and “Dislike!” Once a rating is selected and saved, the rating appears in the “Image Rating” button for quick reference.
6c. Taping “Set as Profile Image” makes this image the current main profile image throughout the system and appears on the client's portfolio page. (FIG. 11F)
6d. Tapping “Delete Image” removes the image from the Image Gallery

### Display Mode

At this point the stylist could choose to start the service. At which point they click the display button engaging the ad, content and promo engine. Should the stylist forget to select the display button the system will automatically switch to this mode after a predefined time, for example, 60 seconds. (FIGS. 12A-12B)

Once in display mode, the client now enjoys targeted ads, content, product promotion and last minute services.

### Method

1. The service provider taps the “Display” button from the kiosk main navigation area. (FIG. 12A)
2. This sets the kiosk into display mode. In display mode, targeted content, ads and promotions are displayed until the session is closed at which time house ads and non-promotional ads and products are displayed. (FIG. 12B)

### Promotions

### Overview

There are three types of promotions: Last Minute Service (LMS), Service Promotions and Product Promotions. All of these targeted promotions are predetermined by the salon owner. They can be changed at any time. (FIGS. 13A-13G)

### 1. Last Minute Service (LMS)

While the customer is engaged with the screen in Display Mode, they may choose to take advantage of a LMS (preselected by the salon owner, possibly at a discount). These will only display if they match the clients profile preferences and the service is either available immediately after the current appointment or while the client is waiting for color to set. When a LMS is tapped by the stylist, the screen displays all current promotions related to that customer. This LMS could be booked right at the kiosk. The service is added to the salon and service provider's schedules and confirmation email goes out to the client. (FIG. 13A)

### Method A (Book Reservation)

1. While the customer is engaged with the screen in Display Mode, the stylist taps on the LMS ad on the right side of the kiosk. (FIG. 13A) This displays the full detail of the service. (FIG. 13B) The client is presented with two choices: To book the appointment or to add it to the shopping cart and book it at a letter date. (FIG. 13B)
2. If the client wants to book the service, the stylist taps the “Book Now” button. This displays the Booking Widget. (FIG. 13E)
3. Stylist selects a week from the “How Many Weeks Out” category.
4. Stylist taps the client's preferred day. (FIG. 13E)
5. Stylist taps the client's preferred time. (FIG. 13E)
6. A columns of available reservations/providers are now displayed. The far left column is highlighted blue showing the current stylist open appointments if available.
7. Stylist taps the preferred reservation and a “Book Now” button is displayed containing the reservation information. After review by the client, the stylist taps the “Book Now” button and a conformation screen is displayed. This also triggers a conformation email to be sent to the client. Both the service provider and the salon schedules are updated with this new reservation.

### Method B (Add to Cart)

1. While the customer is engaged with the screen in Display Mode, the stylist taps on the LMS ad on the right side of the kiosk. This displays the full detail of the service. The client is presented with two choices: To book the appointment or to add it to the shopping cart and book it at a letter date. (FIG. 13B)
2. If the client wants add the service to the cart, the stylist taps the “Add to Cart” button. This displays the shopping cart with this new service added.
3. Tapping the “See More” link in any shopping cart line item displays the full detail of the service.

### 2. Service Promotions

While the customer is engaged with the screen in Display Mode, they may choose to take advantage of a targeted service promotion. These are displayed on the right side of the kiosk. (FIG. 13A) The stylist taps on the requested promotion which displays the full service promotion detail and allows booking or addition to the shopping cart of this promo. In addition to the full detail of a promotion, other related services and products are also displayed based on client preferences.

### Method A (Book Reservation)

1. While the customer is engaged with the screen in Display Mode, the stylist taps on the Service Promotion ad on the right side of the kiosk. This displays the full detail of the service. The client is presented with two choices: To book the appointment or to add it to the shopping cart and book it at a letter date. (FIG. 13C)
2. If the client wants to book the service, the stylist taps the “Book Now” button. This displays the Booking Widget. (FIG. 13E)
3. Stylist selects a week from the “How Many Weeks Out” category. (FIG. 13E)
4. Stylist taps the client's preferred day. (FIG. 13E)
5. Stylist taps the client's preferred time. (FIG. 13E)
6. A columns of available reservations/providers are now displayed. The far left column is highlighted blue showing the current stylist open appointments if available.
7. Stylist taps the preferred reservation and a “Book Now” button is displayed containing the reservation information. After review by the client, the stylist taps the “Book Now” button and a conformation screen is displayed. This also triggers a conformation email to be sent to the client. Both the service provider and the salon schedules are updated with this new reservation.

### Method B (Add to Cart)

1. While the customer is engaged with the screen in Display Mode, the stylist taps on the LMS ad on the right side of the kiosk. (FIG. 13A) This displays the full detail of the service. The client is presented with two choices: To book the appointment or to add it to the shopping cart and book it at a letter date.
2. If the client wants to add the service to the cart, the stylist taps the “Add to Cart” Button. (FIG. 13C). This displays the shopping cart with this new service added. (FIG. 13G)
3. Tapping the “See More” link in any shopping cart line item displays the full detail of the service.

### 3. Product Promotions

While the customer is engaged with the screen in Display Mode, they may choose to take advantage of a targeted product promotion. These are displayed on the right side of the kiosk. (FIG. 13A) The stylist taps on the requested promotion which displays the full product promotion detail and allows the addition to shopping cart of this promo. In addition to the full detail of a promotion, related products are also displayed based on client preferences. (FIG. 13D)

### Method

1. While the customer is engaged with the screen in Display Mode, the stylist taps on the Product Promotion ad on the right side of the kiosk. This displays the product's full detail. (FIG. 13D)
2. If the client wants to purchase the product, the stylist taps the Add to Shopping Cart button (you can add as many as you want). This automatically updates the client's shopping cart. (FIGS. 13D and 13G)
3. The stylist can now tap Display to return to Display Mode or simply do nothing and the system will automatically return to Display Mode in 30 Seconds

### 4. View all Promotions

### Overview

While viewing a LMS or Promotion the stylist my tap on the “Promotions” tab at the top of the kiosk for a full list of targeted product and service promotions and LMSs. (FIG. 13F)

### Method

1. While the customer is engaged with the screen in Display Mode, the stylist taps on a LMS or Product/Service Promotion ad on the right side of the kiosk. This displays the specific Promotion.
2. The stylist taps the “Promotions” tab at the top of the kiosk. This display all LMSs, Product Promotions and Service Promotions. (FIG. 13F)
3. Tapping on any one of these items will display the product or service detail. (FIGS. 13B-13D)
4. The stylist can then continue by choosing either Service Promotion Method A or Service Promotion Method B from above

### Up Sell Services

### Overview

At any time a stylist may up selling a service that can be performed in the chair in addition to the service the client currently receiving. The stylist taps on either corner of the kiosk and then taps dashboard which activate the client profile. Then they can choose the service tab and filter their way into the suggested service. Then they can up sell the service by adding it to the cart. The stylist can also book any service that the salon offers, from the kiosk. This booked service is now added to the service provider's schedule and the salon schedule. A conformation Email is sent to the client.

### Method

1. While the customer is engaged with the screen in Display Mode, the stylist taps either edge of the kiosk (left handed or right handed access). This displays the kiosk access controls.
2. The stylist taps the “Dashboard” button and the clients profile is displayed.
3. From the tabs at the top of the kiosk, the stylist taps the “Services” tab. This displays the main service page including Last Minute Services
4. The stylist now filters their way to the suggested service. For example: the client might be interested in a Pedicure
5. If the client is a female, the stylist taps “Female”. This displays the service categories
6. The stylist taps “Nail Care”. This displays Nail Care categories
7. The stylist taps “Pedicures”. This will then display all services of the type Female/Nail Care/Pedicures
8. The stylist taps the “See More” link in any of the listed pedicures and the service's full detail is displayed
9. The stylist can either book the appointment now or add it to the clients cart for purchase, to be booked at a later date.

### To Book the Appointment:

10. If the client wants to book the service, the stylist taps the “Book Now” button. This displays the Booking Widget.
11. Stylist selects a week from the “How Many Weeks Out” category
12. Stylist taps the client's preferred day
13. Stylist taps the client's preferred time
14. A columns of available reservations/providers are now displayed. The far left column is highlighted blue showing the current stylist open appointments if available.
15. Stylist taps the preferred reservation and a “Book Now” button is displayed containing the reservation information. After review by the client, the stylist taps the “Book Now” button and a conformation screen is displayed. This also triggers a conformation email to be sent to the client. Both the service provider and the salon schedules are updated with this new reservation.

### To Add the Service to the Client's Shopping Cart

10a. The stylist taps the “Add to Cart” button. This displays the Shopping Cart with the pedicure added to it.
11a. The stylist, if finished taps the “Display” button in the kiosk control button group to return to content and advertising or simply does nothing and the system will automatically return to the “Display Mode”

### Up Selling Product

### Overview

At any time the stylist can manually access the product caring but the salon simply by clicking on the product tab, choosing the brand, the category, and the sub category. This displays a list of filtered products which can added to the cart or dispelled in full detail with other related product and then added to the cart.

### Method

1. While the customer is engaged with the screen in Display Mode, the stylist taps either edge of the kiosk (left handed or right handed access). This displays the kiosk access controls.
2. The stylist taps the “Dashboard” button and the clients profile is displayed.
3. From the tabs at the top of the kiosk, the stylist taps the “Products” tab. This displays the main product page including Product Recommendations
4. The stylist now filters their way to the suggested product. For example: the client might be interested in a Color Care Shampoo
5. The stylist taps a product brand for example “Paul Mitchell”. This displays the all Paul Mitchell product categories
6. The stylist taps “Shampoo”. This displays all Paul Mitchell shampoo categories
7. The stylist taps “Color Care”. This will then display a list of all Paul Mitchell Color Care Shampoos
8. The stylist can either add the suggested product to the clients shopping cart or tap anywhere in the product row to see the full detail of the suggested product and then add it to the client's shopping cart. When viewing the product's full detail the screen also displays related products and all available sizes of the suggested product
10. The stylist taps the “Add to Cart” button. This displays the Shopping Cart with the pedicure added to it.
11. The stylist, if finished taps the “Display” button in the kiosk control button group to return to content and advertising or simply does nothing and the system will automatically return to the “Display Mode”

### Rebook

### Overview

At any time during the appointment the stylist can rebook any past service the current client has had regardless of which stylist provided the service. This can be done by tapping the rebook tab at the top of the kiosk screen and then choosing a past service from the list. The stylist then chooses the date and then taps “Book Now”. This adds the appointment to the salon schedule and to the corresponding service provider's schedule. A confirmation email is automatically sent to the client. (FIGS. 14A-14E)

### Method

1. Stylist taps screen to activate dashboard selection button.
2. Stylist taps the “Rebook” tab from to tabs at the top of the kiosk. (FIG. 14A) This displays the Booking Widget.
3. Stylist taps any past service from the list. (FIG. 14B)
4. Stylist selects a week from the “How Many Weeks Out” category. (FIG. 14C)
5. Stylist taps the client's preferred day. (FIG. 14C)
6. Stylist taps the client's preferred time. (FIG. 14C)
7. A columns of available reservations/providers are now displayed. The far left column is highlighted blue showing the current stylist open appointments if available. (FIG. 14C)
8. Stylist taps the preferred reservation and a “Book Now” button is displayed containing the reservation information. After review by the client, the stylist taps the “Book Now” button and a conformation screen is displayed. (FIG. 14D) This also triggers a conformation email to be sent to the client. Both the service provider and the salon schedules are updated with this new reservation. (FIG. 14E)

### Portfolio

### Overview

The portfolio section consists of two areas. My Portfolio is a repository of client photos for this stylist. Photos are added to this list only when approved by the client. Salon Target Portfolio is a subscription base library of current hair styles. (FIGS. 15A-15C)

### My Portfolio

This is the stylist's portfolio of her client's approved images.

### Method

1. A service provider logged into the kiosk taps the “Portfolio” button in the kiosk main navigation area. This displays the “My Portfolio” page. (FIG. 15A)
2. This page contains thumbnails for all current images in the service providers' portfolio. Tapping any thumbnail will display the full image.
3. The service provider can remove the image by clicking on the “Remove” button or return to the portfolio by tapping the “Return” button.

### SalonTarget Gallery.

This is a subscription based library of images featuring current trends in hairstyles. When the salon owner subscribes to the salon target gallery, each stylist kiosk will automatically display the library. This library has a built in filtering system to assist the stylist in finding the correct hairstyles for the client. (FIG. 15C) This image can then be saved to the client's portfolio. The SalonTarget Gallery will replace the typical books of hair styles that salon currently use.

### Method

1. Stylist taps the “Portfolio” button in the kiosk main navigation area. This displays the “My Portfolio” page. (FIG. 15A)
2. The stylist taps the “SalonTarget Gallery” tab at the top of the kiosk. This displays the SalonTarget Gallery page. (FIG. 15C)
3. After consulting with the client the stylist taps their way thought the filter categories: Hair Style, Length, Texture and Color and then taps search. (FIG. 15C)
4. A library of hairstyle images that match the filter choices is displayed. (FIG. 15C)
5. The stylist can rate these images on a scale of 1 to 5 and can save them to the client's image database for future reference.

### Kiosk Alert System

### Overview

At any time during the service the stylist can choose up to 4 alert buttons on the kiosk which will display at the front desk alerting the receptionist. A customizable preloaded message, configured buy the salon owner, will appear at the bottom of the display. (FIG. 16A) The receptionist, upon seeing the message displayed, can respond to the stylist's request with an appropriate response, or can ignore the request. With any of these responses the stylist sees the outcome on the original button she selected. Response types are based on one of three colors: Yellow—still waiting for a response; Green—acknowledged and I can help with your request; Red—acknowledged but I cannot help with your request. (FIGS. 16A-16F)

### Method

1. Stylist taps screen on the left or right edge. Depending on which side, the kiosk navigation button slide out.
2. Stylist then taps which alert they would like to send. For example alert button “1” would be a request for help at the chair: “Send an assistant”. (FIG. 16B)
3. Kiosk alert button turns yellow and displays the number of front desk users are logged in and how many have responded as the system waits for a replay from the front desk(s). (FIG. 16C)
4a. Receptionist sees the request from the specific stylist slide in from the bottom of the screen. This text box contains the text of the request “Send an assistant” and two choices: “Busy” and “On my way”. (FIG. 16D) Receptionist clicks “Busy”. This changes the stylist's alert button do Red, indicating the Front Desk cannot help with the request. After 30 seconds the alert buttons slide off screen and reset to original colors. (FIG. 16F)
4b. Receptionist sees the request from the specific stylist slide in from the bottom of the screen. This text box contains the text of the request “Send an assistant” and two choices: “Busy” and “On my way”. (FIG. 16D) Receptionist clicks “One my way”. This changes the stylist's alert button do Green, indicating the Front Desk can help with the request. After 30 seconds the alert buttons slide off screen and reset to original colors. (FIG. 16F)
4c. Receptionist sees the request from the specific stylist slide in from the bottom of the screen. This text box contains the text of the request “Send an assistant” and two choices: “Busy” and “On my way”. (FIG. 16D) Receptionist ignores (does not take an action). The stylist's alert button stays Yellow, indicating the Front Desk has not responded to the request. After 30 seconds the alert buttons slide off screen and reset to original colors. (FIG. 16F)

In the case of more than one Front Desk being logged in, for example in a large salon, the stylist's alert button will show the number of Front Desk users and what their response is until one has responded with “One my way”. This response closes that request and all alerts displays reset. (FIG. 16E)

### My Profile

### Overview

Information related to the service provider, entered by the owner into the service provider's record from the administration tool, is displayed on the service providers profile page: stylist's bio, contact info, work schedule, alerts from other salon employees or customers and a few service provider selected photos. This area is essentially their virtual desktop. (FIGS. 17A-17G)

### Method

1. When a service provider is logged into the kiosk, they tap the “My Profile” button in the kiosk main navigation area. (FIG. 17A) This will display the service provider's profile main page
2. The service provider taps the Schedule tab from the top of the kiosk. This displays current the weekly schedule for this service provider. (FIG. 17C)
3. The service provider can move the calendar forward or backward in time be simply tapping the arrows at the top of the calendar. (FIG. 17C)

### Schedule

The schedule shows the weekly schedule for the specific stylist showing all booked appointments. The stylist has the ability to see future and past appointments using this interface.

### Method

1. When a service provider is logged into the kiosk, they tap the “My Profile” button in the kiosk main navigation area. (FIG. 17A) This will display the service provider's profile main page. (FIG. 17B)
2. The service provider taps the Schedule tab from the top of the kiosk. This displays current the weekly schedule for this service provider. (FIG. 17C)
3. The service provider can move the calendar forward or backward in time be simply tapping the arrows at the top of the calendar.

### Alert Messaging System

This alert messaging system is used to notify the service provider. This system can be accessed by the Salon Owner(s), approved third-party vendors or anyone who has approved access (e.g., the privileges) to post a message to the service provider via the Salon Target System website. The service provider is made aware of an alert via the “My Profile” button highlighting. Once the alert has been read, the “My Profile” button's color is reset. (FIGS. 17A-17G)

There are two types of alerts, internal and external.

### Internal Alert (Owner/Employee)

This alert comes from another employee via the admin system, an input device at the kiosk or the front desk.

### Method

1. Through the administration tool, the owner can choose to send an alert to any or all of the employees.
2. When logged in to the kiosk, the service provider will notice the “My Profile” button has changed color to yellow. (FIG. 17A)
3. The service provider taps the “My Profile” button in the kiosk main navigation area. This displays the service provider's main profile page. (FIG. 17B)
4. The service provider taps the “Alerts” tab at the top of the kiosk. This displays a list of alerts in chronological order. (FIG. 17E)
5. The service provider taps the alert they want to review. This displays a full detail of the alert. Alerts can also contain images. (FIG. 17F)
6. The service provider can either tap the “Delete Message” button to remove the message or tap the “Alerts” tab to return to the alerts main page.
7. After all new alerts have been read the system resets the “My Profile” button to its original color.

### External Alert (Client/Vendor)

This alert comes from a client via the website or from a note submitted on a reservation. If the alert comes from a vendor, it is sent through the Salon Target System Website. When a reservation is submitted online, any notes from the customer will appear as an alert in this list. This alerts the service provider prior to the appointment of any intentions that the client may have. When the service provider retrieves the alert message, the “My Profile” button resets to the original color state and the alert is flagged as viewed. New alerts are at the top of the list. The service provider has the ability to delete and alert messages after they have been retrieved. (FIGS. 17A-17G)

Also messages from customer sent via ST website will trigger and icon to display on the client's profile page in the kiosk. This will act as a reminder to the stylist that a message sent which she may wish to review.

Messages can be sent by the stylist from the kiosk via an input device to other salon employees or the front desk.

### Method (Client)

1. When a client creates a reservation either from the Salon Target System Website or through the front desk, notes added to the reservation record are automatically sent to the alert messaging system.
2. When logged in to the kiosk, the service provider will notice the “My Profile” button has changed color to yellow. (FIG. 17D)
3. The service provider taps the “My Profile” button in the kiosk main navigation area. This displays the service provider's main profile page. (FIG. 17B)
4. The service provider taps the “Alerts” tab at the top of the kiosk. This displays a list on alerts in chronological order. (FIG. 17E)
5. The service provider taps the alert they want to review. This displays a full detail of the alert. Alerts can also contain images. (FIG. 17F)
6. The service provider can either tap the “Delete Message” button to remove the message or tap the “Alerts” tab to return to the alerts main page.
7. After all new alerts have been read the system resets the “My Profile” button to its original color.

### Method (Vendor)

1. A Vendor logins in to the Salon Target System Website.
2. The vendor navigates to the messaging area of the website.
3. The vendor chooses the recipient group.
4. The vendor creates the message and click send.
5. When logged in to the kiosk, the service provider will notice the “My Profile” button has changed color to yellow. (FIG. 17D)
6. The service provider taps the “My Profile” button in the kiosk main navigation area. This displays the service provider's main profile page. (FIG. 17B)
7. The service provider taps the “Alerts” tab at the top of the kiosk. This displays a list on alerts in chronological order. (FIG. 17E)
8. The service provider taps the alert they want to review. This displays a full detail of the alert. Alerts can also contain images. (FIG. 17F)
9. The service provider can either tap the “Delete Message” button to remove the message or tap the “Alerts” tab to return to the alerts main page.
10. After all new alerts have been read the system resets the “My Profile” button to its original color.

### Time Card

The time card tab is activated and displayed when an employee's payment method is set up as hourly in the administration site. When an employee's payment method is set to hourly, they use this page to track their time thought out the day, including start of the day, end of the day and break times. Also displayed on this screen is a time card history. (FIGS. 17A-17G)

### Method

1. When the service provider is login into the kiosk
2. The service provider taps the “My Profile” button in the kiosk main navigation area. (FIG. 17A)
3. The service provider taps the “Time Card” tab at the top of the kiosk. (FIG. 17G)
4. Depending on the event, the service provider taps one of the available button choices: “start day”, “break start”, “break end” or “end day”. (FIG. 17G)
5. When the button is tapped a timestamp is recorded in to the Salon Target System.
6. Time cards are displayed in the “Time Card History” on the Time Card page. (FIG. 17G)

### About Us:

This is page is used to inform the client of the salon's mission, history and company information. Basically any information the salon owner would want the clients to be informed of. The About Us page is created and managed by the salon owner with in the Salon Target System Administration tool. (FIGS. 18A-18E)

### Method

1. The service provider taps the “About Us” button in the kiosk main navigation area. (FIG. 18A) This displays the “About Us” page. (FIG. 18B)
2. When the client has finished reviewing the page, the service provider taps the “Dashboard” button from the kiosk main navigation area. This displays the client's profile or the service provider can tap the “Display” button from the kiosk main navigation area. This puts the kiosk into Display Mode, showing targeted content, ads and promotions.

### Menu

The “Menu” tab displays the current list of services offered by the salon. The service provider can tap on any of the menu items to some the client more information. These Menu items are created and managed by the salon owner with in the Salon Target System Administration tool. (FIGS. 18A-18E)

### Method

1. The service provider taps the “About Us” button in kiosk main navigation area. (FIG. 18A)
2. The service provider taps the “Menu” tab at the top of the kiosk. This displays the salon/spa “Menu” page. (FIG. 18C)
3. To view more information on one of the Menu items, the service provider can tap anywhere in the item's row. This will display the full detail of the item. (FIG. 18D)

### Advertiser List

Tapping the “Advertiser List” tab displays the current list of advertisers that are running ads in the Salon. This list is populated by the Salon Target System Adserver. (FIGS. 18A-18E)

### Method

1. The service provider taps the “About Us” button in kiosk main navigation area. (FIG. 18A)
2. The service provider taps the “Advertiser List” tab at the top of the kiosk. This displays the salon/spa's current list of active advertiser. (FIG. 18E)

### Check Out Process

When the service provider has finished the client's service, they now must close the session. They can also check the client out from the chair. The service provider simply taps the “Session Completed” button on the kiosk. This closes the session, alerts the front desk and displays a pop up window on the kiosk asking if the client would like to check out at the chair with either of two methods of payment, instead of at the front desk. The two payment methods are using your credit card that the salon has on file or using our kiosk camera to scan a QR Code or Bar Code displayed on the clients smart phone (such as Google Wallet, LevelUp, Pay Pal, etc.). (FIGS. 19A-19G)

If the client chooses to use their stored Credit Card, they simply review the transaction/check out screen and approve payment. The service provider taps Cash Out. A receipt is sent to the client via email and the front desk is notified.

If the client chooses to scan a QR or Bar Code first review and approve the transaction/check out screen. Once approved the stylist taps the scan button and the client holds their phone up to the camera. Once the core is captured, their credit card is charged the balance and a receipt is sent to the client via email.

### Method

1. Service provider taps the “Session Completed button on the kiosk. (FIG. 19B) This closes the session, changes the status at the front desk, removes the reservation from the kiosk screen and displays a pop-up asking whether the client would like to check out at the chair using one of two payment methods, instead of going to the front desk. (FIG. 19C)
2a. Client wants to use the front desk to cash out. Service provider taps “No” and the pop-up is closed. The client is cashed out at the front desk. (FIGS. 19E-19F)
2b. Clients wants to cash out at the chair. (FIG. 19D)
3a. Cash out using their stored credit card the salon has on file.

a. Service provider taps use credit card on file. This displays the transaction screen

b. The client reviews and approves the transaction and the service provider taps “Cash Out”.

c. The client's credit card is bill and a receipt is sent to the client via email.

d. Front desk is alerted that the reservation has been paid.

3b. Cash out using a smart phone.

a. Service provider taps “Use smart Phone”. This displays the transaction screen.

b. The client reviews and approves the transaction and the service provider taps “Cash Out”.

c. The onboard camera is activated and scans the QR or Bar code displayed on the smart phone into the system.

d. The client's credit card is billed and a receipt is sent to the client via email.

e. Front desk is alerted that the reservation has been paid.

4. Kiosk display remaining reservations for the stylist. (FIG. 19G)

### SalonTarget Advertising Engine (Adserver)

The SalonTarget System Adserver is used to serve targeted ads to targeted machines (kiosks), not webpages. This targeting is based on matching and authenticating the salon or spa client's preferences to advertiser requested demographics. Once a client at the kiosk is authenticated by the service provider, targeted ad is pushed to that specific client's kiosk with demographics that match those required by the advertiser. This guarantees the advertiser's ads are displaying to their defined audience.

### Method

1. Advertiser logs into their Salon Target System account at www.salontarget.com or creates a new account
2. Advertiser creates a new ad campaign or reinitializes a completed ad campaign from their campaign history
3. Advertiser chooses the targeting of their campaign. Targeting can include client demographics, geographic region and/or specific salons and spas.
4. Advertiser chooses a specific campaign type. (These are advertising packages with different costs, impression numbers, ad placements, run lengths, etc.)
5. Once the advertiser has completed their targeting, they can upload new creatives (ads) into the Salon Target System Adserver or create a new ad using the Salon Target System Ad Creator which is a web-based widget used to create simple, effective ads when the advertiser does not have access to a design or advertising agency.
6. Once the creatives are published into the system, the campaign will be active.
7. As appropriate machines (service providers authenticating clients at kiosks) come online and are in Display Mode, the Salon Target System Adserver will match the ad campaign's requested demographics to that of the kiosk. When a kiosk is not in Display Mode, ad impression is halted as to not waste the advertiser's ad impressions.
8. Targeted and authenticated ads are now displayed on the kiosk and reported back to the Salon Target System Adserver for review by the advertiser.

Other embodiments are within the scope and spirit of the invention. For example, due to the nature of software, functions described above can be implemented using software, hardware, firmware, hardwiring, or combinations of any of these. Features implementing functions can also be physically located at various positions, including being distributed such that portions of functions are implemented at different physical locations.

Further, while the description above refers to the invention, the description may include more than one invention.

What is claimed is:

1. A salon management system comprising:
a server storing information relating to salon employees and salon clients and the server storing information relating to salon employee service appointments; and
at least one employee terminal connected to the server by a network and adapted to send data to and receive data from the server; and
wherein after a salon employee logs into an employee terminal, the server sends information to the employee terminal identifying the salon employees next salon client and the server sends advertising content to the employee terminal selected based upon the information relating to the next salon client stored at the server.

2. The salon management system according to claim 1 further comprising a chair located within view of the employee terminal, wherein the chair includes a user interface device enabling the next salon client to interact with the employee terminal.

3. The salon management system according to claim 2 wherein the user interface element is a touch pad.

4. The salon management system according to claim 2 wherein the user interface element is a computer mouse.

5. The salon management system according to claim 2 wherein the user interface element is a track ball.
